(19) United States
(12) Patent Application Publication
(10) Pub. No.: US 2024/0126310 A1
(43) Pub. Date: Apr. 18, 2024

(54) MIXING CARTRIDGE FOR A SANITARY FITTING, AND SANITARY FITTING COMPRISING A MIXING CARTRIDGE

(71) Applicant: Grohe AG, Hemer (DE)

(72) Inventor: Ole Benedikt KOSTORZ, Menden (DE)

(73) Assignee: Grohe AG, Hemer (DE)

(21) Appl. No.: 18/276,958

(22) PCT Filed: Feb. 9, 2022
(86) PCT No.: PCT/EP2022/053056

§ 371 Date: Sep. 8, 2023

(30) Foreign Application Priority Data
Feb. 12, 2021 (DE) 102021103363.2

(51) Int. Cl. G05D 23/13

(52) U.S. Cl. CPC G05D 23/1313

(57) ABSTRACT

A mixing cartridge for a sanitary faucet, comprising:
a cartridge housing having a first longitudinal axis, a first cold-water inlet for cold water, and at least one first warm-water inlet for warm water;
a mount disposed in the cartridge housing and having a second longitudinal axis, a second cold-water inlet and a second warm-water inlet;
a pressure compensation element having a third longitudinal axis, a third cold-water inlet and a third warm-water inlet, wherein the third cold-water inlet opens into a cold-water chamber and the third warm-water inlet opens into a warm-water chamber, and wherein the pressure compensation element is movably disposed in the mount for at least partially equalizing a cold-water pressure of the cold water in the cold-water chamber and a warm-water pressure of the warm water in the warm-water chamber in parallel to the first longitudinal axis of the cartridge housing.

This invention relates to a mixing cartridge for a sanitary faucet and a sanitary faucet having a mixing cartridge. Sanitary faucets are used in particular to provide a liquid, in particular water, on demand at a sink, a washbasin, a shower or a bathtub.

Sanitary faucets can comprise a mixing cartridge for mixing cold water and warm water to form a mixed water. This mixing cartridge can be used to mix the cold water and warm water at a certain mixing ratio depending on the desired mixed-water temperature. If a cold-water pressure of the supplied cold water and/or a warm-water pressure of the supplied warm water fluctuate when the cold water and warm water are mixed, this may result in a fluctuating mixed-water temperature. To prevent this, a pressure-equalization valve can be connected upstream of the sanitary faucet, by means of which the cold-water pressure and warm-water pressure in a cold-water supply line and a warm-water supply line can be equalized. However, the disadvantage of such pressure compensation valves is that they require additional installation space, for instance in a wall or below a washstand, which is frequently not available. Moreover, there is an increased installation effort.

Therefore, the invention addresses the problem of solving at least one part of the issues described with reference to the prior art and, in particular, of providing a mixing cartridge for a sanitary faucet, which can at least partially prevent the fluctuations of the mixed-water temperature while avoiding an increased installation effort. Moreover, a sanitary faucet is also to be disclosed, by means of whose mixing cartridge fluctuations in the mixed-water temperature can be at least partially prevented while avoiding an increased installation effort.

These problems are solved by a mixing cartridge and a sanitary faucet having the features of the independent claims. Further advantageous embodiments of the invention are specified in the dependent claims. It will be appreciated that the features listed individually in the dependent claims may be combined in any technologically useful manner and define further embodiments of the invention. In addition, the features indicated in the claims are further specified and explained in the description, wherein further preferred embodiments of the invention are illustrated.

A mixing cartridge for a sanitary faucet, having at least the features listed below, contributes to solving the problem:
a cartridge housing having a first longitudinal axis, at least one first cold-water inlet for cold water, and at least one first warm-water inlet for warm water;
a mount disposed inside the cartridge housing and having a second longitudinal axis, at least one second cold-water inlet for the cold water, and at least one second warm-water inlet for the warm water;
a pressure compensation element having a third longitudinal axis, at least one third cold-water inlet for the cold water and at least one third warm-water inlet for the warm water, wherein the at least one third cold-water inlet opens out into a cold-water chamber and the at least one third warm-water inlet opens out into a warm-water chamber, and wherein the pressure compensation element is movably disposed in the mount for at least partially equalizing a cold-water pressure of the cold water in the cold-water chamber and a warm-water pressure of the warm water in the warm-water chamber in parallel to the first longitudinal axis of the cartridge housing.

The mixing cartridge can be used in particular for a sanitary faucet that is used to provide a mixed-water supply on demand at a washbasin, a sink, a shower or a bathtub. For this purpose, in particular cold water at a cold-water temperature and warm water at a warm-water temperature can be routed to the mixing cartridge. The mixing cartridge can be used to mix the cold water and the warm water to form a mixed water having a desired mixed-water temperature. The cold-water temperature is in particular at most 30° C. (Centigrade), preferably 1° C. to 30° C., particularly preferably 5° C. to 30° C. and/or the warm-water temperature is in particular at most 90° C., preferably 30° C. to 90° C., particularly preferably 55° C. to 65° C. The mixing cartridge can be disposed for instance in a faucet housing of the sanitary faucet. In particular, the faucet housing is at least partly made of plastic and/or (cast) metal, such as brass. The faucet housing can be attached to a support, such as a countertop, a sink, a washbasin, a bathtub, or a shower.

The mixing cartridge has a cartridge housing. The cartridge housing can at least partly be made of plastic and/or (cast) metal, such as brass. Furthermore, the cartridge housing can be at least partly tubular and/or cylindrical in shape. Moreover, the cartridge housing may have at least partly a circular cross-section. Moreover, the cartridge housing may be formed of several parts. For instance, the cartridge housing may comprise an upper housing part and a lower housing part, which may be bolted or screwed together, for instance. In addition, the cartridge housing may be configured to be at least partly installable in the faucet housing of the sanitary faucet. The cartridge housing has a first longitudinal axis, which may be in particular straight. Furthermore, the first longitudinal axis may be a first center axis of the cartridge housing. The cartridge housing has at least one first cold-water inlet for cold water and at least one first warm-water inlet for warm water. The at least one first cold-water inlet and/or the at least one first warm-water inlet extend in particular orthogonally to the first longitudinal axis or (with respect to the first longitudinal axis) in a radial direction through an outer wall of the cartridge housing. A first mounting space may be formed inside the cartridge housing, which is in particular at least partly cylindrical in shape. Moreover, the first mounting space may extend in particular along the first longitudinal axis.

Furthermore, the mixing cartridge has a mount disposed in the cartridge housing. The mount can at least partly be made of plastic and/or (cast) metal, such as brass. The mount may, for instance, be designed in the manner of a plastic die-cast component. Furthermore, the mount may be at least partly tubular and/or cylindrical in shape. Moreover, the mount may have at least partly a circular cross-section. The mount extends along a second longitudinal axis, which in particular may be straight. The second longitudinal axis is in particular a center axis of the mount. Furthermore, the second longitudinal axis of the mount may extend in parallel to the first longitudinal axis of the cartridge housing and/or be aligned with the first longitudinal axis of the cartridge housing. In particular, the mount is disposed in the first mounting space of the cartridge housing. For this purpose, the mount may (orthogonal to the first longitudinal axis), for instance, have an outer diameter that is (substantially) equal to an inner diameter of the first mounting space of the cartridge housing. In particular, the mount may be rotatably disposed in the first mounting space of the cartridge housing and/or (parallel and/or orthogonal to the second longitudinal axis) free of play. In addition, the mount has at least one second cold-water inlet for the cold water and at least one second warm-water inlet for the warm water. The at least one second cold-water inlet is in particular at least partly aligned with the at least one first cold-water inlet of the cartridge housing and/or is connected thereto in a fluid-conducting manner. The at least one second warm-water inlet is in particular at least partially aligned with the at least one first warm-water inlet of the cartridge housing and/or is connected thereto in a fluid-conducting manner. Furthermore, the at least one second cold-water inlet and/or the at least one second warm-water inlet may extend, in particular, orthogonally to the second longitudinal axis or (in relation to the second longitudinal axis) in the radial direction through an outer wall of the mount. Moreover, the at least one second cold-water inlet and/or the at least one second warm-water inlet can be designed in the manner of a slot. To this end, the at least one second cold-water inlet and/or the at least one second warm-water inlet may extend in a circumferential direction of the mount, for instance at an angle of 150° to 210°, preferably 170° to 190°, particularly preferably (approximately) 180°, about the second longitudinal axis. A second mounting space can be formed inside the mount, which is in particular at least partly cylindrical in shape. Moreover, the second mounting space may extend in particular in parallel to the second longitudinal axis.

In addition, the mixing cartridge has a pressure compensation element extending along a third longitudinal axis. In particular, the pressure compensation element may at least partly be made of plastic, ceramics and/or (cast) metal, such as brass. For instance, the pressure compensation element may be designed in the manner of a plastic die-cast component. The third longitudinal axis is, in particular, straight. The third longitudinal axis is in particular a center axis of the pressure compensation element. Furthermore, the third longitudinal axis of the pressure compensation element may extend in parallel to the first longitudinal axis of the cartridge housing and/or to the second longitudinal axis of the mount. The pressure compensation element has at least one third cold-water inlet for the cold water and at least one third warm-water inlet for the warm water. The at least one third cold-water inlet may (in particular, depending on the position of the pressure compensation element in the mount) in particular be at least partly aligned with the at least one second cold-water inlet of the mount orthogonally to the third longitudinal axis or in the radial direction. The at least one third warm-water inlet may (in particular, depending on the position of the pressure compensation element in the mount) in particular be at least partly aligned with the at least one second warm-water inlet of the cartridge housing orthogonally to the third longitudinal axis or in the radial direction. Furthermore, the at least one third cold-water inlet and/or the at least one third warm-water inlet may extend in particular orthogonally to the third longitudinal axis or (in relation to the third longitudinal axis) in the radial direction through a side wall of the pressure compensation element. The at least one third cold-water inlet opens into a cold-water chamber for the cold water, and the at least one third warm-water inlet opens into a warm-water chamber for the warm water. The pressure compensation element is movably disposed in the mount for at least partially equalizing a cold-water pressure of the cold water in the cold-water chamber and a warm-water pressure of the warm water in the warm-water chamber in parallel to the first longitudinal axis of the cartridge housing. During the motion of the pressure compensation element, in particular an outer surface of the pressure compensation element slides along an inner surface of a second mounting space of the mount. In particular, the pressure compensation element is configured such that the pressure compensation element automatically moves in parallel to the first longitudinal axis of the cartridge housing in the mount when the cold-water pressure of the cold water in the cold-water chamber deviates from the warm-water pressure of the warm water in the warm-water chamber. To this end, a cold-water flow cross-section formed between the at least one second cold-water inlet of the mount and the at least one third cold-water inlet of the pressure compensation element, through which the cold water can flow into the cold-water chamber, can change in the opposite direction to a warm-water flow cross-section formed between the at least one second warm-water inlet of the mount and the at least one third warm-water inlet of the pressure compensation element, through which the warm water can flow into the warm-water chamber. In this way, the cold-water pressure of the cold water in the cold-water chamber and the warm-water pressure of the warm water in the warm-water chamber can be at least partially equalized or matched. The at least one second cold-water inlet and the at least one second warm-water inlet of the mount and the at least one third cold-water inlet and the at least one third warm-water inlet of the pressure compensation element can in particular be designed in such a way that an increase of the cold-water flow cross-section results in a decrease of the warm-water flow cross-section or a decrease of the cold-water flow cross-section results in an increase of the warm-water flow cross-section. For instance, when the cold-water pressure of the cold water in the cold-water chamber is greater than the warm-water pressure of the warm water in the warm-water chamber, the pressure compensation element moves toward its warm-water chamber as a result of the pressure difference, such that the cold-water flow cross-section decreases and the warm-water flow cross-section increases. On the other hand, when the cold-water pressure of the cold water in the cold-water chamber is lower than the warm-water pressure of the warm water in the warm-water chamber, the pressure compensation element moves toward its cold-water chamber as a result of the pressure difference, such that the cold-water flow cross section increases and the warm-water flow cross section decreases. The pressure compensation element moves in parallel to the first longitudinal axis of the cartridge housing in the mount, in particular, until the cold-water pressure of the cold water in the cold-water chamber and the warm-water pressure of the warm water in the warm-water chamber are (substantially) equal. Thus, the pressure compensation element can be used to throttle an inflow of cold water into the cold-water chamber when the cold-water pressure of the cold water in the cold-water chamber is greater than the warm-water pressure of the warm water in the warm-water chamber. Accordingly, the pressure compensation element can be used to throttle an inflow of warm water into the warm-water chamber when the warm-water pressure of the warm water in the warm-water chamber is greater than the cold-water pressure of the cold water in the cold-water chamber. Due to the pressure compensation element disposed in the mixing cartridge, fluctuations in the mixed-water temperature can at least be reduced without having to arrange an external pressure compensation valve in the supply lines of the sanitary faucet for the cold water and/or the warm water.

The pressure compensation element may be formed to be at least partly tubular. Furthermore, the pressure compensation element may be at least partly cylindrical in shape. Moreover, the pressure compensation element may have at least partly a circular cross-section.

The cold-water chamber and the warm-water chamber may at least partly be formed inside the pressure compensation element. Furthermore, the cold-water chamber and/or the warm-water chamber can be formed inside the pressure compensation element in the manner of drilled holes. Moreover, the cold-water chamber and/or the warm-water chamber in the pressure compensation element may be cylindrical in shape.

A partition may be formed in the pressure compensation element to separate the cold-water chamber and the warm-water chamber. In particular, the partition is rigid and/or integral with the pressure compensation element. Furthermore, the partition may be centered in the pressure compensation element in the direction of the third longitudinal axis.

The at least one third cold-water inlet or the at least one third warm-water inlet may be formed inside a side wall of the pressure compensation element. In particular, the at least one third cold-water inlet and/or the at least one third warm-water inlet may be formed inside a side wall of the pressure compensation element.

The pressure compensation element may have a cold-water output at a first longitudinal end and a warm-water output at a second longitudinal end. The cold-water output and/or the warm-water output may in particular be an opening of the pressure compensation element.

A cold-water duct for the cold water may be formed in the mount. The cold-water duct can, for instance, be designed in the manner of a drilled hole and/or extend at least partly in parallel to the third longitudinal axis of the pressure compensation element. The cold water can be routed, in particular, from the first longitudinal end of the pressure compensation element to a cold-water outlet of the mount through the cold-water duct.

The mount may have a cold-water outlet for the cold water and a warm-water outlet for the warm water at a third longitudinal end. In particular, the warm water can be guided from the warm-water output of the pressure compensation element through the mount to the warm-water outlet. In particular, the third longitudinal end of the mount represents an end face of the mount. The cold-water outlet and/or the warm-water outlet are designed in particular in the manner of openings in the mount. Furthermore, the cold-water outlet and/or the warm-water outlet may have a semicircular cross-section. At its third longitudinal end, the mount contacts in particular a control disk having a control disk opening, to which the mount can be rotated for setting the mixed-water temperature in the first mount space of the cartridge housing. The mount is rotatable about its axis of rotation between a first end position and a second end position. In the first end position, only the cold-water outlet of the mount is aligned with the control disk opening, such that only cold water can exit the mixing cartridge. In the second end position, only the warm-water outlet of the mount is aligned with the control disk opening, such that only warm water can exit the mixing cartridge. Between the first end position and the second end position, both the cold-water outlet and the warm-water outlet of the mount are aligned with the control disk opening. The further the mount is rotated from the first end position towards the second end position, the further the cold-water outlet is closed and the warm-water outlet is opened such that the mixed-water temperature rises from the cold-water temperature to the warm-water temperature. In the first end position of the mount, the mixed water consists in particular only of the cold water and in the second end position of the mount in particular only of the warm water.

The mount may be rotatable about an axis of rotation for setting a mixed-water temperature of a mixed water consisting of the cold water and the warm water. For this purpose, the mount can be connected to a shaft, for instance, at a fourth longitudinal end. In particular, the shaft is rotatably mounted in the cartridge housing. Furthermore, the shaft can be connected to an actuating element of the sanitary faucet, for instance in the manner of a rotary lever or rotary handle, which can be used to set the mixed-water temperature by a user of the sanitary faucet.

According to a further aspect of the invention, a sanitary faucet comprising a faucet body having a mixing cartridge according to the invention is proposed. For further details of the sanitary faucet, reference is made in full to the description of the mixing cartridge.

The invention and the technical environment are explained in more detail below with reference to the figures. It should be noted that the figures show a particularly preferred embodiment variant of the invention, but the invention is not limited thereto. The same reference numerals are used for the same components in the figures. In an exemplary and schematic manner,

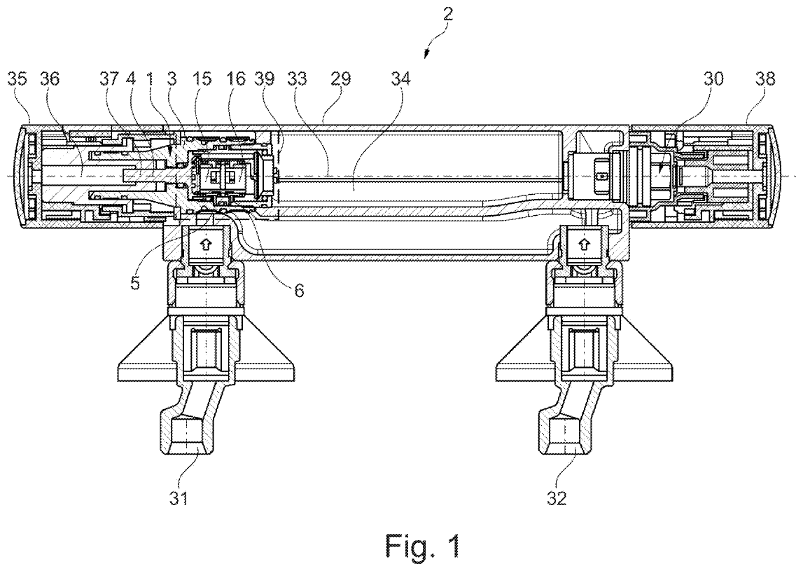

FIG. 1 shows a longitudinal section of a sanitary faucet;

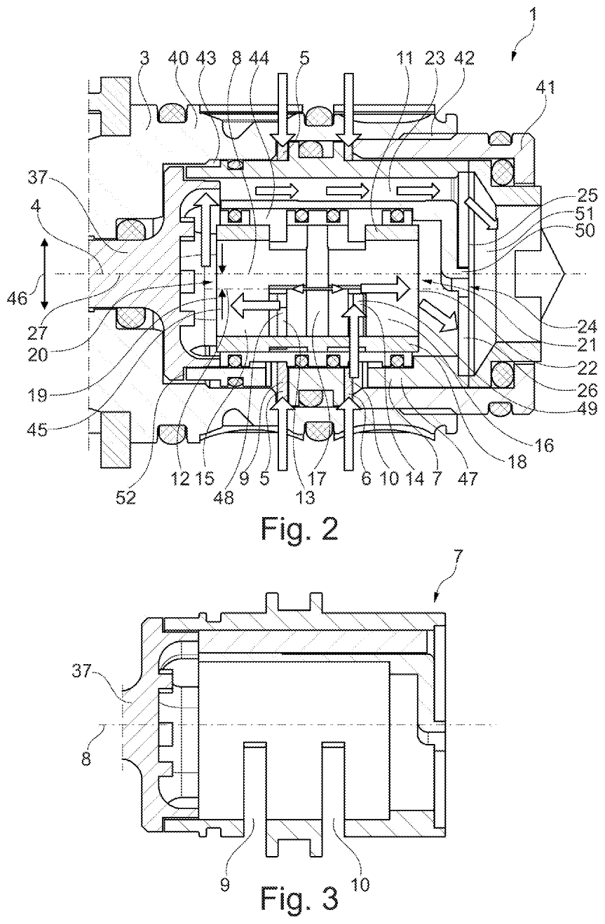

FIG. 2 shows a longitudinal section of a part of a mixing cartridge of the sanitary faucet;

FIG. 3 shows a longitudinal section of a mount of the mixing cartridge;

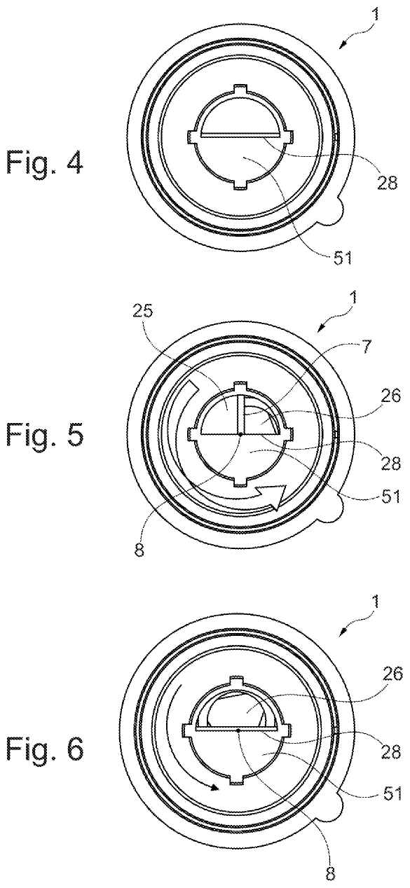

FIG. 4 shows the mixing cartridge in a first operating position, viewed towards a mixed-water outlet;

FIG. 5 shows the mixing cartridge in a second operating position, viewed towards the mixed-water outlet; and

FIG. 6 shows the mixing cartridge in a third operating position, viewed towards the mixed-water outlet.

FIG. 1 shows a longitudinal section of a sanitary faucet 2, which is mounted to a wall (not shown here). The sanitary faucet 2 comprises a faucet body 29 having a mixing cartridge 1 and a valve 30. The faucet body 29 can be supplied with cold water via a cold-water intake 31 and with warm water via a warm-water intake 32. The cold water and the warm water can be routed to the mixing cartridge 1 through fluid ducts formed in the faucet body 29. The mixing cartridge 1 can be used to mix the cold water and the warm water to form a mixed water having a mixed-water temperature. The mixing cartridge 1 has a cartridge housing 3 that is (substantially) tubular in shape and extends along a longitudinal axis 4 of the mixing cartridge 1 or along a longitudinal housing axis 33 of the faucet body 29. At least one first cold-water inlet 5 and at least one first warm-water inlet 6 are formed in the cartridge housing 3. The variant of the embodiment of the mixing cartridge 1 shown here has a plurality of first cold-water inlets 5 and warm-water inlets 6 distributed in a circumferential direction about the longitudinal axis 4 of the cartridge housing 3. The cold water of a cold-water chamber 15 can be routed via the first cold-water inlets 5 of the mixing cartridge 1 and the warm water of a warm-water chamber 16 can be routed via the first warm-water inlets 6 of the mixing cartridge 1. The cold water and warm water can be discharged at a desired mixing ratio through the mixing cartridge 1 into a mixed-water duct 34, such that a mixed water having a desired mixed-water temperature is produced. For setting the mixing ratio or the mixed-water temperature, the sanitary faucet 2 has a first actuating element 35, which in this case is designed in the manner of a rotary handle. The first actuating element 35 can be rotated about an axis of rotation 36, which in this case is aligned with the longitudinal axis 33 of the housing, and is connected to a shaft 37 of the mixing cartridge 1. The mixed water can be supplied to the valve 30 via the mixed-water duct 34 of the faucet body 29, through which valve the mixed water can be discharged via a drain opening of the faucet body 29 (not visible here). The valve 30 can be actuated via a second actuating element 38, which is also designed in the manner of a rotary handle.

FIG. 2 shows an enlarged view of the area of mixing cartridge 1 marked by a rectangle 39 in FIG. 1. The cartridge housing 3 comprises an upper housing part 40 and a lower housing part 41, which are screwed together via a thread 42. A first mounting space 43 for a mount 7 is formed in the cartridge housing 3, which is (substantially) cylindrical in shape. The mount 7 is (mainly) tubular in shape and extends along a second longitudinal axis 8, which is aligned there with the first longitudinal axis 4 of the cartridge housing 3. Furthermore, the mount 7 has an outer diameter that is (largely) equal to an inner diameter of the first mount 43. Therefore, the mount 7 has a round cross-section. A second mounting space 44, which is cylindrical in shape, is formed in the mount 7 for a pressure compensation element 11. The pressure compensation element 11 extends along a third longitudinal axis 12, which extends at an offset 45 in parallel to the first longitudinal axis 4 of the cartridge housing 3 and the second longitudinal axis 8 of the mount 7. The cold-water chamber 15 and the warm-water chamber 16, which are separated from each other by a first partition 17 of the pressure compensation element 11 inside the pressure compensation element 11, are formed in the pressure compensation element 11. The cold water can enter the cold-water chamber 15 through the first cold-water inlets 5 of the cartridge housing 3, a second cold-water inlet 9 of the mount 7, and a third cold-water inlet 13 of the pressure compensation element 11. Accordingly, the warm-water may enter the warm-water chamber 16 through the first warm-water inlets 6 of the cartridge housing 3, a second warm-water inlet 10 of the mount 7, and a third warm-water inlet 14 of the pressure compensation element 11. The second cold-water inlet 9 and the second warm-water inlet 10 of the mount 7 extend in a radial direction 46 through an outer wall 47 of the mount 7 with respect to the first longitudinal axis 4 of the cartridge housing 3. The third cold-water inlet 13 and the third warm-water inlet 14 of the pressure compensation element 11 extend with respect to the first longitudinal axis 4 of the cartridge housing 3 in the radial direction 46 through a side wall 18 of the pressure compensation element 11.

When a cold-water pressure of the cold water in the cold-water chamber 15 differs from a warm-water pressure of the warm water in the warm-water chamber 16, the pressure compensation element 11 automatically moves in parallel to the first longitudinal axis 4 of the cartridge housing 3 in the mount 7. In so doing, a cold-water flow cross-section 48 formed between the second cold-water inlet 9 of the mount 7 and the third cold-water inlet 13 of the pressure compensation element 11, through which the cold water can flow into the cold-water chamber 15, change in the opposite direction to a warm-water flow cross-section 49 formed between the second warm-water inlet 10 of the mount 7 and the third warm-water inlet 14 of the pressure compensation element 11, through which the warm water can flow into the warm water chamber 16. In this way, the cold-water pressure of the cold water in the cold-water chamber 15 and the warm-water pressure of the warm water in the warm-water chamber 16 can be at least partially equalized or matched. The second cold-water inlet 9 and the second warm-water inlet 10 of the mount 7, and the third cold-water inlet 13 and the third warm-water inlet 14 of the pressure compensation element 11, are configured such that an increase in the cold-water flow cross-section 48 results in a decrease in the warm-water flow cross-section 49, or a decrease in the cold-water flow cross-section 48 results in an increase in the warm-water flow cross-section 49. For instance, when the cold-water pressure of the cold water in the cold-water chamber 15 is greater than the warm-water pressure of the warm water in the warm-water chamber 13, the pressure compensation element 11 moves toward its warm-water chamber 16 such that the cold-water flow cross-section 48 decreases and the warm-water flow cross-section 49 increases. On the other hand, when the cold-water pressure of the cold water in the cold-water chamber 15 is lower than the warm-water pressure of the warm water in the warm-water chamber 13, the pressure compensation element 11 moves toward its cold-water chamber 15 such that the cold-water flow cross section 48 increases and the warm-water flow cross section 49 decreases.

The pressure compensation element 11 has a cold-water output 20 at a first longitudinal end 19, through which the cold water can exit the pressure compensation element 11. The cold water flows from the cold-water output 20 of the pressure compensation element 11 to a cold-water outlet 25 of the mount 7 via a cold-water duct 23. The cold-water duct 23 extends through the mount 7 in parallel to the second longitudinal axis 8 of the mount 7. Furthermore, the pressure compensation element 11 has a warm-water output 22 at a second longitudinal end 21, through which the warm water can exit the pressure compensation element 11. The warm water flows from the warm-water output 22 of the pressure compensation element 11 to a warm-water outlet 26 of the mount 7 through the mount 7. The cold-water outlet 25 and the warm-water outlet 26 are formed at a third longitudinal end 24 of the mount 7 and are separated from each other by a second partition 50. The third longitudinal end 24 of the mount 7 contacts a control disk 51, which is attached to the cartridge housing 3 in a non-rotatable manner. At a fourth longitudinal end 52 of the mount 7, the shaft 37 is attached to the mount 7 such that the mount 7 with the pressure compensation element 11 in the first mount 43 of the cartridge housing 3 can be rotated about a rotational axis 27 relative to the control disk 51 for setting the mixed-water temperature. The axis of rotation 27 is aligned there with the first longitudinal axis 4 of the cartridge housing 3.

FIG. 3 shows a longitudinal section of the mount 7 with the shaft 37. There, in particular, it can be seen that the second cold-water inlet 9 and the second warm-water inlet 10 are slot-shaped. To this end, the second cold-water inlet 9 and the second warm-water inlet 10 extend in a circumferential direction of the mount 7 about the second longitudinal axis 8.

FIG. 4 shows the mixing cartridge 1, viewed towards the control disk 51. In FIG. 4, the mixing cartridge 1 is in a first operating position, in which only the cold-water outlet 25 is aligned with a semicircular control disk opening 28. Thus, in the first operating position, only cold water can exit the mixing cartridge 1, i.e., the mixed-water temperature is equal to a cold-water temperature of the cold water and is thus at its minimum.

FIG. 5 shows the mixing cartridge 1, also viewed towards the control disk 51. In FIG. 5, the mixing cartridge 1 is in a second operating position, in which, compared to the first operating position, the mount 7 has been rotated by 90° counterclockwise about the second longitudinal axis 8 of the mount 7 by the shaft 37 shown in FIGS. 1-3, such that both the cold-water outlet 25 and the warm-water outlet 26 are aligned with the control disk opening 28. In the second operating position, both cold water and warm water thus exit from the mixing cartridge 1.

FIG. 6 shows the mixing cartridge 1, viewed towards the control disk 51. In FIG. 6, the mixing cartridge 1 is in a third operating position, in which, compared to the second operating position, the mount 7 has been rotated by a further 90° counterclockwise about the second longitudinal axis 8 of the mount 7 by the shaft 37 shown in FIGS. 1-3. In the third operating position, only the warm-water outlet 26 is aligned with the control disk opening 28, i.e., only warm water can exit the mixing cartridge 1. The mixed-water temperature is thus equal to a warm-water temperature of the warm water and is thus at its maximum.

This invention makes it possible to at least partially prevent variations in mixed-water temperature while avoiding an increased installation effort.

### LIST OF REFERENCES

1 mixing cartridge
2 sanitary faucet
3 cartridge housing
4 first longitudinal axis
5 first cold-water inlet
6 first warm-water inlet
7 mount
8 second longitudinal axis
9 second cold-water inlet
10 second warm-water inlet
11 pressure compensation element
12 third longitudinal axis
13 third cold-water inlet
14 third warm-water inlet
15 cold-water chamber
16 warm-water chamber
17 partition
18 side wall
19 first longitudinal end
20 cold-water output
21 second longitudinal end
22 warm-water output
23 cold-water duct
24 third longitudinal end
25 cold-water outlet
26 warm-water outlet
27 axis of rotation
28 Control disk opening
29 faucet body
30 valve
31 cold-water intake
32 warm-water intake
33 longitudinal axis of body
34 mixed-water duct
35 first actuating element
36 axis of rotation
37 shaft
38 second actuating element
39 rectangle
40 upper housing part
41 lower housing part
42 thread
43 first mounting space
44 second mounting space
45 offset
46 radial direction
47 outer wall
48 cold-water flow cross section
49 warm-water flow cross section
50 second partition
51 control disk
52 fourth longitudinal end

1. A mixing cartridge (1) for a sanitary faucet (2), comprising at least:
a cartridge housing (3) having a first longitudinal axis (4), at least one first cold-water inlet (5) for cold water, and at least one first warm-water inlet (6) for warm water;
a mount (7) disposed in the cartridge housing (3) and having a second longitudinal axis (8), at least one second cold-water inlet (9) for the cold water and at least one second warm-water inlet (10) for the warm water;
a pressure compensation element (11) having a third longitudinal axis (12), at least one third cold-water inlet (13) for the cold water and at least one third warm-water inlet (14) for the warm water, wherein the at least one third cold-water inlet (13) opens out into a cold-water chamber (15) and the at least one third warm-water inlet (14) opens into a warm-water chamber (16), and wherein the pressure compensation element (11) is movably disposed in the mount (7) for at least partially equalizing a cold-water pressure of the cold water in the cold-water chamber (15) and a warm-water pressure of the warm water in the warm-water chamber (16) in parallel to the first longitudinal axis (4) of the cartridge housing (3).

2. The mixing cartridge (1) according to claim 1, wherein the pressure compensation element (11) is at least partly tubular in shape.

3. The mixing cartridge faucet (1) according to claim 1, wherein the cold-water chamber (15) and the warm-water chamber (16) are designed at least partly formed inside the pressure compensation element (11).

4. The mixing cartridge (1) according to claim 1, wherein a partition (17) separating the cold-water chamber (15) from the warm-water chamber (16) is formed in the pressure compensation element (11).

5. The mixing cartridge (1) according to claim 1, wherein the at least one third cold-water inlet (13) or the at least one third warm-water inlet (14) are formed inside a side wall (18) of the pressure compensation element (11).

6. The mixing cartridge (1) according to claim 1, wherein the pressure compensation element (11) has a cold-water output (20) at a first longitudinal end (19) and a warm-water output (22) at a second longitudinal end (21).

7. The mixing cartridge (1) according to claim 1, wherein a cold-water duct (23) for the cold water is formed in the mount (7).

8. The mixing cartridge (1) according to claim 1, wherein the mount (7) has a cold-water outlet (25) for the cold water and a warm-water outlet (26) for the warm water at a third longitudinal end (24).

9. The mixing cartridge (1) according to claim 1, wherein the mount (7) can be rotated about an axis of rotation (27) for setting a mixed-water temperature of a mixed water mixed from the cold water and the warm water.

10. A sanitary faucet (2), comprising a faucet body (29) with a mixing cartridge (1) according to claim 1.
